(19) United States
(12) Patent Application Publication
(10) Pub. No.: US 2016/0258041 A1
(43) Pub. Date: Sep. 8, 2016

(54) DIE-CASTABLE NICKEL BASED SUPERALLOY COMPOSITION

(71) Applicant: UNITED TECHNOLOGIES CORPORATION, HARTFORD, CT (US)

(72) Inventor: Awadh B. Pandey, Jupiter, FL (US)

(21) Appl. No.: 14/822,066

(22) Filed: Aug. 10, 2015

Related U.S. Application Data
(60) Provisional application No. 62/035,525, filed on Aug. 11, 2014.
(60) Provisional application No. 62/035,526, filed on Aug. 11, 2014.

(51) Int. Cl. C22C 19/05; B22D 25/02; F01D 5/28; B22D 21/00

(52) U.S. Cl. CPC C22C 19/055; B22D 21/005; B22D 25/02; F01D 5/28; F05D 2220/32; F05D 2230/21; F05D 2300/175; F05D 2300/177

(57) ABSTRACT

A die-cast nickel based superalloy including 3-7 wt % Tungsten (W), 3-7 wt % Tantalum (Ta), and 0.5-3.0 wt % Aluminum (Al).

### CROSS REFERENCE TO RELATED APPLICATION

This application claims the benefit of provisional application Ser. No. 62/035,525, filed Aug. 11, 2014 and provisional application Ser. No. 62/035,526, filed Aug. 11, 2014.

### BACKGROUND

The present disclosure relates to nickel based superalloys and, more particularly, to readily castable nickel based superalloys for gas turbine engine components.

Gas turbine engines typically include a compressor section to pressurize airflow, a combustor section to burn a hydrocarbon fuel in the presence of the pressurized air, and a turbine section to extract energy from the resultant combustion gases. Gas path components, often include cooling airflows such as external film cooling, internal air impingement, and forced convection, either separately, or in combination to continuously remove thermal energy.

The gas path components, such as nozzles (stationary vanes) and buckets (rotating blades), are typically formed of stainless steel, nickel, and cobalt-base alloys that exhibit desirable mechanical and thermal properties. Nickel based superalloys are of high strength, about 1500 MPa, and increased temperature capability, such as above 700° C. These Nickel Base Superalloys (IN100) are investment casted and are not readily castable via a die casting process as the IN100 alloy breaks apart.

### SUMMARY

A die-cast nickel based superalloy according to one disclosed non-limiting embodiment of the present disclosure includes 3-7 wt % Tungsten (W), 3-7 wt % Tantalum (Ta), and 0.5-3.0 wt % Aluminum (Al).

A further embodiment of the present disclosure includes, wherein the 3-7 wt % Tungsten (W) includes 4.5-5.5 wt % Tungsten (W).

A further embodiment of any of the foregoing embodiments of the present disclosure includes, wherein the 4.5-5.5 wt % Tantalum (Ta) includes 3-7 wt % Tantalum (Ta).

A further embodiment of any of the foregoing embodiments of the present disclosure includes 0.15-0.2 wt % Carbon (C).

A further embodiment of any of the foregoing embodiments of the present disclosure includes 8.0-11.0 wt % Chromium (Cr).

A further embodiment of any of the foregoing embodiments of the present disclosure includes 13.0-17.0 wt % Cobalt (Co).

A further embodiment of any of the foregoing embodiments of the present disclosure includes 2.0-4.0 wt % Molybdenum (Mo)

A further embodiment of any of the foregoing embodiments of the present disclosure includes 3.0-5.0 wt % Titanium (Ti).

A further embodiment of any of the foregoing embodiments of the present disclosure includes 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), and the balance Nickel (Ni) plus incidental impurities.

A further embodiment of any of the foregoing embodiments of the present disclosure includes 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

A further embodiment of any of the foregoing embodiments of the present disclosure includes a die-cast nickel based superalloy.

A further embodiment of any of the foregoing embodiments of the present disclosure includes a die-cast nickel based superalloy.

A further embodiment of any of the foregoing embodiments of the present disclosure includes a die-cast nickel based superalloy die cast at a cooling rate on the order of at least equal 10̂2 degree F. per second.

A further embodiment of any of the foregoing embodiments of the present disclosure includes, wherein an average gran size that is ASTM 3 or smaller.

A further embodiment of any of the foregoing embodiments of the present disclosure includes, wherein a degree of elemental segregation is lower than investment casting.

A nickel based superalloy A further embodiment of the present disclosure includes 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 4.5-5.5 wt % Tungsten (W), 4.5-5.5 wt % Tantalum (Ta), 0.5-3.0 wt % Aluminum (Al), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

A further embodiment of any of the foregoing embodiments of the present disclosure includes gas turbine engine rotor blade of a nickel based superalloy.

A further embodiment of any of the foregoing embodiments of the present disclosure includes a die-cast nickel based superalloy die cast at a cooling rate on the order of at least equal 10̂2 degree F. per second.

A gas turbine engine rotor blade A further embodiment of the present disclosure includes a die cast nickel based superalloy including a 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 4.5-5.5 wt % Tungsten (W), 4.5-5.5 wt % Tantalum (Ta), 0.5-3.0 wt % Aluminum (Al), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

A further embodiment of any of the foregoing embodiments of the present disclosure includes a die-cast nickel based superalloy die cast at a cooling rate on the order of at least equal 10̂2 degree F. per second.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of an example gas turbine engine architecture;

FIG. 2 is a schematic cross-section of another example gas turbine engine architecture;

FIG. 3 is an enlarged schematic cross-section of an engine turbine section; and

FIG. 4 is an exploded view of rotor assembly with a single representative turbine blade manufactured of a die castable Nickel Base Superalloy.

### DETAILED DESCRIPTION

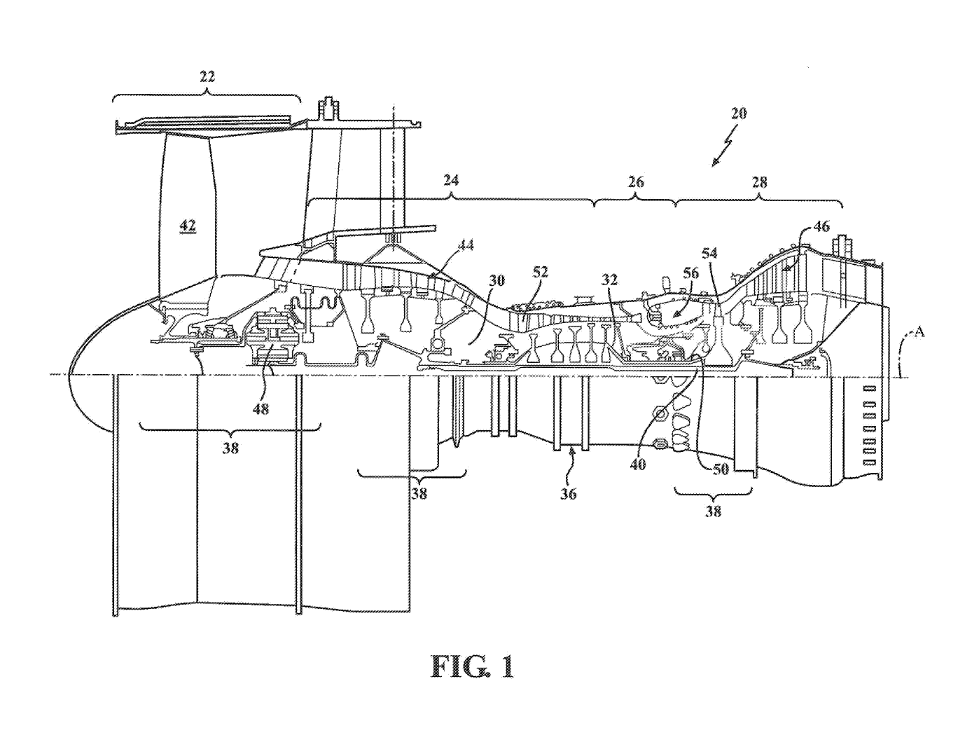

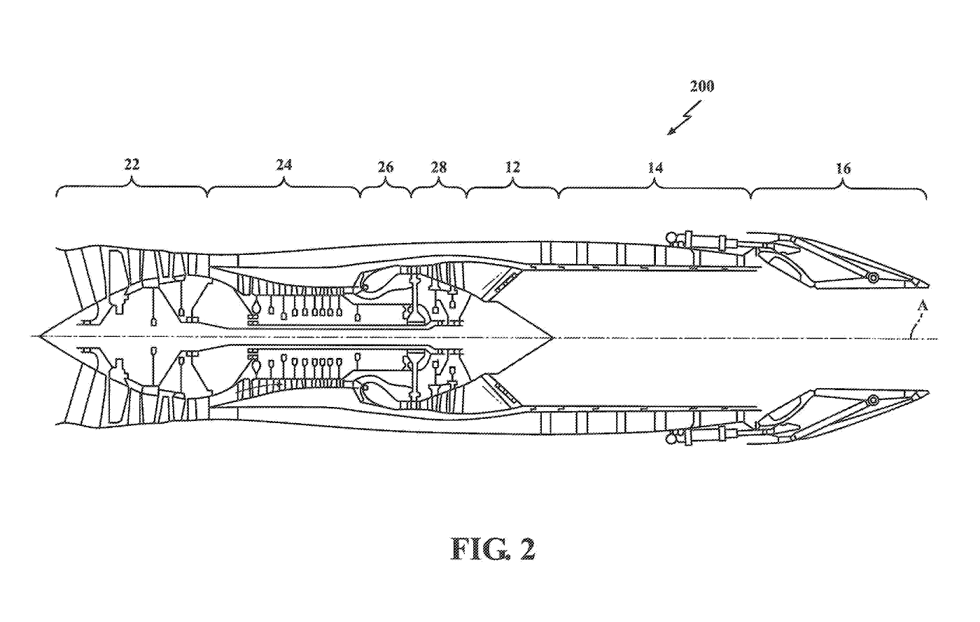

FIG. 1 schematically illustrates a gas turbine engine 20. The gas turbine engine 20 is disclosed herein as a two-spool turbo fan that generally incorporates a fan section 22, a compressor section 24, a combustor section 26 and a turbine section 28. Alternative engine architectures 200 might include an augmentor section 12, an exhaust duct section 14 and a nozzle section 16 (FIG. 2) among other systems or features. The fan section 22 drives air along a bypass flowpath add into the compressor section 24 along a core flowpath, for compression and communication into the combustor section 26, then expansion through the turbine section 28. Although depicted as a turbofan in the disclosed non-limiting embodiment, it should be appreciated that the concepts described herein are not limited to use with turbofans as the teachings may be applied to other types of turbine engine architectures such as turbojets, turboshafts, and three-spool (plus fan) turbofans.

The engine 20 generally includes a low spool 30 and a high spool 32 mounted for rotation about an engine central longitudinal axis A relative to an engine case structure 36 via several bearing compartments 38. The low spool 30 generally includes an inner shaft 40 that interconnects a fan 42, a low pressure compressor (“LPC”) 44 and a low pressure turbine (“LPT”) 46. The inner shaft 40 drives the fan 42 directly or through a geared architecture 48 to drive the fan 42 at a lower speed than the low spool 30. The high spool 32 includes an outer shaft 50 that interconnects a high pressure compressor (“HPC”) 52 and a high pressure turbine (“HPT”) 54. A combustor 56 is arranged between the HPC 52 and the HPT 54.

The core airflow is compressed by the LPC 44, then the HPC 52, mixed with the fuel and burned in the combustor 56, then expanded over the HPT 54 and the LPT 46, to rotationally drive the respective low spool 30 and high spool 32 in response to the expansion.

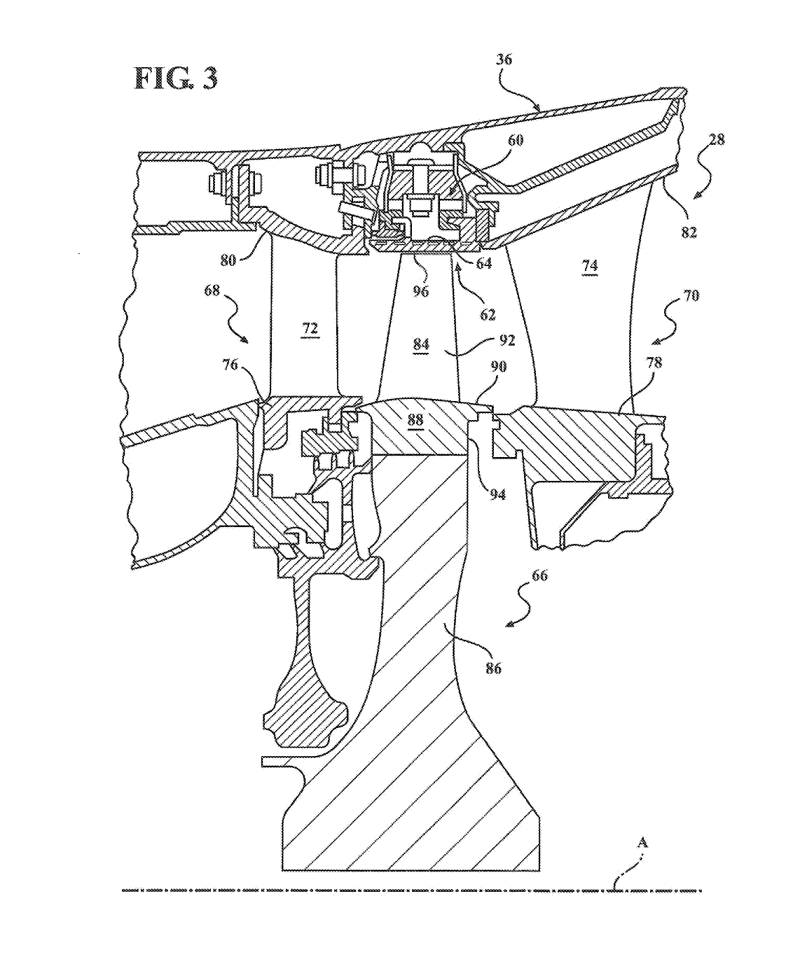

With reference to FIG. 3, an enlarged schematic view of a portion of the HPT 54 is shown by way of example; however, other engine sections will also benefit herefrom. A full ring shroud assembly 60 mounted to the engine case structure 36 supports a Blade Outer Air Seal (BOAS) assembly 62 with a multiple of circumferentially distributed BOAS 64 proximate to a rotor assembly 66 (one schematically shown).

The full ring shroud assembly 60 and the BOAS assembly 62 are axially disposed between a forward stationary vane ring 68, and an aft stationary vane ring 70. Each vane ring 68, 70, includes an array of vanes 72, 74 that extend between a respective inner vane platform 76, 78, and an outer vane platform 80, 82. The outer vane platforms 80, 82 are attached to the engine case structure 36.

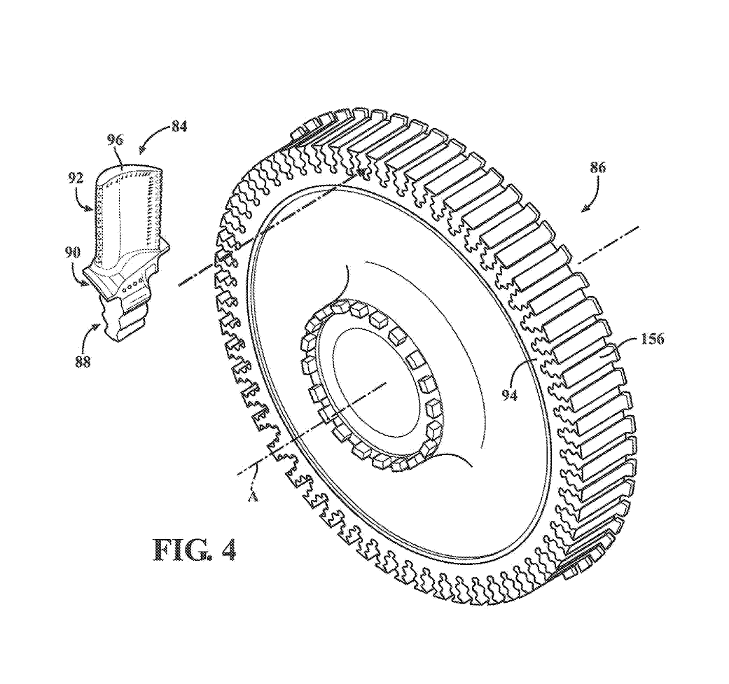

The rotor assembly 66 includes an array of blades 84 circumferentially disposed around a disk 86. Each blade 84 includes a root 88, a platform 90 and an airfoil 92 (also shown in FIG. 4). The blade roots 88 are received within a rim 94 of the disk 86 and the airfoils 92 extend radially outward such that a tip 96 of each airfoil 92 is adjacent to the blade outer air seal (BOAS) assembly 62. The platform 90 separates a gas path side inclusive of the airfoil 92, and a non-gas path side inclusive of the root 88.

The blades 84 are commonly manufactured of a nickel based Superalloy, such as IN100 alloy. IN100, however, is not manufacturable via a die casting process as the IN100 alloy breaks apart due to the formation of extremely fine gamma prime precipitates with high volume fraction due to the high cooling rates associated with die casting which provides higher cooling rates than investment casting. In one example die casting provide cooling rates on the order of at least equal 10̂2 degree F. per second. The inventors have determined that the relatively high content of aluminum is a primary cause of these castability issues. The nickel based superalloy according to one disclosed non-limiting embodiment, provides an average gran size that is very fine e.g. ASTM 3 or smaller, and the degree of elemental segregation is significantly lower than investment casting due to higher cooling rate in the die casting process. The nickel based superalloy eliminates the potential for cracking when die-cast. This nickel based superalloy contains a relatively lower Aluminum wt % than that of IN100 as well as 3-7 wt % Tungsten (W), and 3-7 wt % Tantalum (Ta), to provide a readily die castable alloy without loss of mechanical properties capability. The tungsten and tantalum provide strengthening through solid solution, precipitation and carbide formation mechanisms to compensate for the loss in strength from lower aluminum content in the alloy composition. The tungsten forms solid solution with the nickel and also forms MC, M23C6 and M6C carbides (where M is the metal). The tantalum forms solid solution with nickel and also forms MC carbides in the alloy composition. The tantalum also improves creep strength. The tantalum facilitates precipitation strengthening through gamma prime formation where these elements can be substituted for aluminum. In addition, higher titanium content in the alloy composition also provides larger volume fraction of gamma prime for strengthening.

The nickel based superalloy according to one disclosed non-limiting embodiment contains a relatively lower wt % Aluminum, such as 0.5-3.0 wt %, a higher wt % Tungsten, such as 3-7 wt % Tungsten, and a higher wt % Tantalum (Ta), such as 3-7 wt % Tantalum (Ta), as compared to that of IN100 that includes 5-6 wt % Aluminum, with no Tungsten and no Tantalum.

### EXAMPLE

An example of the nickel based superalloy according to the disclosed non-limiting embodiment, consists of 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 4.5-5.5 wt % Tungsten (W), 4.5-5.5 wt % Tantalum (Ta), 0.5-3.0 wt % Aluminum (Al), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

It should be appreciated that at least the 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) are acceptable impurities.

The disclosed nickel based superalloy is readily cast via die casting and has been demonstrated good quality without cracking. In addition, the disclosed nickel based superalloy composition has provided at least equivalent or better tensile properties than IN100 alloy. Example components, thus formulated and processed as described above are readily die-cast and exhibit a desirable combination of yield strength, stress rupture properties, environmental resistance, microstructural stability and cost well suited for gas turbine engine applications.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A die-cast nickel based superalloy comprising:
3-7 wt % Tungsten (W), 3-7 wt % Tantalum (Ta), and 0.5-3.0 wt % Aluminum (Al).

2. The die-cast nickel based superalloy as recited in claim 1, wherein said 3-7 wt % Tungsten (W) includes 4.5-5.5 wt % Tungsten (W).

3. The die-cast nickel based superalloy as recited in claim 1, wherein said 4.5-5.5 wt % Tantalum (Ta) includes 3-7 wt % Tantalum (Ta).

4. The die-cast nickel based superalloy as recited in claim 1, further comprising: 0.15-0.2 wt % Carbon (C).

5. The die-cast nickel based superalloy as recited in claim 1, further comprising: 8.0-11.0 wt % Chromium (Cr).

6. The die-cast nickel based superalloy as recited in claim 1, further comprising: 13.0-17.0 wt % Cobalt (Co).

7. The die-cast nickel based superalloy as recited in claim 1, further comprising: 2.0-4.0 wt % Molybdenum (Mo)

8. The die-cast nickel based superalloy as recited in claim 1, further comprising: 3.0-5.0 wt % Titanium (Ti).

9. The die-cast nickel based superalloy as recited in claim 1, further comprising: 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), and the balance Nickel (Ni) plus incidental impurities.

10. The die-cast nickel based superalloy as recited in claim 1, further comprising: 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

11. A gas turbine engine component comprising a die-cast nickel based superalloy as claimed in claim 1.

12. A gas turbine engine rotor blade comprising a die-cast nickel based superalloy as claimed in claim 1.

13. A gas turbine engine component comprising a die-cast nickel based superalloy as claimed in claim 1, said die-cast nickel based superalloy die cast at a cooling rate on the order of at least equal 10̂2 degree F. per second.

14. The die-cast nickel based superalloy as recited in claim 13, wherein an average gran size that is ASTM 3 or smaller.

15. The die-cast nickel based superalloy as recited in claim 13, wherein a degree of elemental segregation is lower than investment casting.

16. A nickel based superalloy consisting of: 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 4.5-5.5 wt % Tungsten (W), 4.5-5.5 wt % Tantalum (Ta), 0.5-3.0 wt % Aluminum (Al), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

17. A gas turbine engine rotor blade comprising a nickel based superalloy as claimed in claim 14.

18. A gas turbine engine rotor blade comprising a die-cast nickel based superalloy as claimed in claim 8, said die-cast nickel based superalloy die cast at a cooling rate on the order of at least equal 10̂2 degree F. per second.

19. A gas turbine engine rotor blade, comprising:
a die cast nickel based superalloy including a 0.15-0.2 wt % Carbon (C), 0-0.2 wt % Manganese (Mn), 0-0.2 wt % Silicon (Si), 0-0.015 wt % Phosphorus (P), 0-0.015 wt % Sulfur (S), 8.0-11.0 wt % Chromium (Cr), 13.0-17.0 wt % Cobalt (Co), 2.0-4.0 wt % Molybdenum (Mo), 4.5-5.5 wt % Tungsten (W), 4.5-5.5 wt % Tantalum (Ta), 0.5-3.0 wt % Aluminum (Al), 3.0-5.0 wt % Titanium (Ti), 0.01-0.02 wt % Boron (B), 0.7-1.2 wt % Vanadium (V), 0.03-0.09 Zirconium (Zr), 0-0.30 wt % Iron (Fe), 0-0.00003 wt % Bismuth (Bi), 0-0.0005 wt % Lead (Pb), 0-0.00005 wt % Selenium (Se), 0-0.00005 wt % Tellurium (Te), 0-0.00005 wt % Thallium (Tl) and the balance Nickel (Ni) plus incidental impurities.

20. A gas turbine engine rotor blade as recited in claim 19, said die-cast nickel based superalloy die cast at a cooling rate on the order of at least equal 10̂2 degree F. per second.
